(19) United States
(12) Patent Application Publication
(10) Pub. No.: US 2007/0180250 A1
(43) Pub. Date: Aug. 2, 2007

(54) Apparatus and Method for Improving Security Level In Card Authentication System

(76) Inventor: Jun-Ho Choi, Seoul (KR)

Correspondence Address: Frank Chau, Esq.;F. CHAU & ASSOCIATES, LLC, 130 Woodbury Road, Woodbury, NY, 11797, US

(21) Appl. No.: 11/560,086

(22) Filed: Nov. 15, 2006

(30) Foreign Application Priority Data
Jan. 20, 2006 (KR) 2006-06240

(51) Int. Cl. H04L 9/00

(52) U.S. Cl. 713/176

(57) ABSTRACT

A memory card controller includes a random number generator and an encoder. The random number generator creates random numbers from one of a plurality of unique numbers and the encoder generates a cipher text from the random numbers and embedded keys. A memory card authentication system includes storage media and a memory card controller. The memory card controller receives the unique numbers from the storage medium. Every storage medium has a unique number that is used as a seeds to generate random numbers. This increases the randomness of the random numbers and hence enhances a security level in the memory card authentication system.

### CROSS-REFERENCE TO RELATED APPLICATION

The present application claims priority under 35 U.S.C. §119 to Korean Patent Application No. 2006-06240 filed on Jan. 20, 2006, the entire contents of which are hereby incorporated by reference.

### BACKGROUND

1. Technical Field

The present invention relates to card authentication systems and in particular, to a card authentication system and method for improving a security level thereof.

2. Discussion of the Related Art

A card authentication system generally determines a pass or fail condition of an authentication (i.e., whether a proper storage medium is inserted) during an authorizing operation between a storage medium, e.g., a memory card, and a host. If the authentication is successful, the host is able to retrieve data from the storage medium and/or store desired data into the storage medium.

Such an authorizing operation may be carried out with a random number generator. The random number generator may generate the same random numbers from input seeds. However, when the same seeds are used, the same random numbers may be generated. Therefore, the same random numbers can be more easily discovered by a hacker thereby weakening a security level of the whole authentication system.

Therefore, it is desirable to enhance the randomness of the random numbers produced by the random number generator to raise the security level of a card authentication system. As used herein, the term “randomness” refers to the extent to which a generated random number cannot be anticipated by any pattern or mathematical formula. Therefore, increasing or enhancing the randomness of the random numbers lessens the likelihood that the generated random numbers can be anticipated.

### SUMMARY OF THE INVENTION

Embodiments of the present invention are directed to a card authentication system having an enhanced security level with higher randomness of random numbers made by a random number generator.

Embodiments of the present invention are also directed to a method for card authentication capable of improving a security level with higher randomness of random numbers made by a random number generator.

According to one embodiment of the present invention, a card controller may comprise a random number generator and an encoder. The random number generator may produce a random number from a unique number provided from a storage medium. The encoder may accept the random number.

According to an embodiment, a memory card may comprise a storage medium storing a unique number and a card controller producing a random number from the unique number. A cipher text may be generated from the random number.

The card controller may comprise a random number generator producing the random number from the unique number and an encoder generating the cipher text from the random number. The random number generator may receive a first key from a user and produce the random number from the unique number and the first key. The encoder may generate the cipher text from the random number and an embedded second key. The encoder may transfer the random number and the cipher text to a host.

In another embodiment, a storage medium may store the random number produced from the random number generator. When the storage medium stores the random number, the random number generator may produce a new random number from the stored random number. The unique number may depend on the kind of storage medium used.

A card authentication system may comprises a hose and memory card storing a unique number, generating a random number from the unique number, generating a cipher text from the random number, and providing the cipher text to the host.

The memory card may comprise a storage medium storing the unique number and a card controller producing the random number from the unique number and generating the cipher text from the random number. The card controller may comprise a random number generator producing a first random number from the unique number provided by the storage medium and an encoder generating the cipher text from the first random number. The random number generator may receive a first key from a user and produce the random number from the unique number and the first key. The encoder may generate the cipher text from the first random number and an embedded second key. The encoder may transfer the first random number and the cipher text to a host. The host may comprise a decoder decrypting the cipher text by means of a third key embedded in the host and generating a second random number from the decrypted cipher text and a random number comparator configured to compare the first random number with the second random number.

A method for authorizing a card may comprise finding whether there is a stored random number, accepting a unique number from a storage medium when the random number is absent, and generating a first random number from the unique number.

A further understanding of the several embodiments of the present invention may be realized by reference to the remaining portions of the specification and the attached drawings.

### BRIEF DESCRIPTION OF THE FIGURES

Non-limiting and non-exhaustive embodiments of the present invention will be described with reference to the following figurers, where like reference numerals refer to like parts throughout the various figures unless otherwise specified. In the figures:
FIG. 1 is a block diagram illustrating a card authentication system in accordance with an embodiment of the invention; and
FIG. 2 is a flow chart showing a method for operating the card authentication system in accordance with an embodiment of the invention.

### DETAILED DESCRIPTION OF EXEMPLARY EMBODIMENTS

Embodiments of the invention will be described below in more detail with reference to the accompanying drawings. The invention may, however, be embodied in different forms and should not be constructed as limited to the embodiments set forth herein.

FIG. 1 is a block diagram illustrating a card authentication system 100 in accordance with an embodiment of the present invention. Referring to FIG. 1, the card authentication system 100 may be comprised of a memory card 105 and a host 130. The memory card 105 may be installed in the host 130.

The memory card 105 and the host 130 may each have their own keys. The card authentication system 100 may execute an authorizing operation by means of two embedded keys when the memory card 105 links up with the host 130. For example, the card authentication system 100 enables communication between the memory card 105 and the host 130 when the embedded keys are identical to each other.

For example, memory card 105 may be a MultiMedia Card (MMC), Secure Digital (SD) card, MiniSD, MicroSD, Compact Flash, Memory Stick, removable/transportable hard disk or any other memory card either commercially available or in development. The memory card 105 may vary in operation speed, card size, and security level depending on the kind of memory card 105 used. The memory card 105 may comprise a storage medium 110 and a card controller 120.

The storage medium 110 may include a block for storing unique numbers 113 and a block for storing data 115. The unique numbers may be used as seeds during an encryption operation. A general storage medium, such as, for example, a hard disk drive (HDD), nonvolatile memory, and so forth, may have its own unique number for identification. The block storing the unique number 113 may also contain additional information, for example, a manufacturer name, a package type, manufacture time information represented in a unit of time such as minutes and/or seconds. The unique number may be different for each storage medium used.

The storage medium 110 may be an electrically erasable/programmable read-only memory (EEPROM), a NOR flash memory, a NAND flash memory, a phase-changeable random access memory (PRAM), a magnetic random access memory (MRAM), a ferroelectric random access memory (FRAM) or any other form of storage medium.

The card controller 120 may be comprised of a random number generator 123 producing random numbers from a unique number supplied by the storage medium 110, and an encoder 125 generating a cipher text. The card controller 120 may use the unique number (e.g., 64-bit unique number) for a seed, to improve the randomness of random numbers.

The random number generator 123 may be used for the authorizing operation to protect an embedded key value. The random number generator 123 may produce random numbers RN from the seed input thereto. Therefore, a seed that is simple in numeric structure may result in random numbers that would be more easily discovered by a hacker and hence may weaken a security level of the whole authentication system.

As illustrated in FIG. 1, the random number generator 123 may produce a first random number RN1 from a unique number received as a seed. The random number generator 123 may further accept a first key K1. The encoder 125 may generate a cipher text by encrypting the first random number RN1 and a second key K2 embedded therein. The card controller 120 may transfer the first random number RN1 and the cipher text to the host 130.

The host 130 may be a computer, digital camera, a digital camcorder, MP3 player, printer, mobile telephone, personal digital assistant (PDA), or any other device that can accept a memory card 105. The host 130 may include a decoder 133 and a random number comparator 135. The decoder 133 may decrypt the cipher text transferred from the card controller 120. The random number comparator 135 may determine whether the decoded random number RN2 is identical to the random number RN1 directly supplied from the card controller 120.

If the memory card 105 links up with the host 130, the card controller 120 may accept the unique number from the block 113 storing the unique numbers within the storage medium 110. The random number generator 123 may produce the first random numbers RN1 by using the accepted unique number as a seed. The random number generator 123 may further receive the first key K1 (e.g., 56-bit key) input by a user. By the random number generator 123 using the unique number and the first key K1 for the seed, the randomness of the first random number RN1 may be strengthened.

The encoder 125 may generate the cipher text by encrypting the first random number RN1 and the second key K2 embedded therein. The card controller 120 may transfer the first random number RN1 and the cipher text to the host 130.

The decoder 133 may generate the second random number RN2 from deciphering the cipher text, which is transferred from the card controller 120, using a third key K3. The random number comparator 135 may determine whether the first random number RN1 transferred from the card controller 120 is identical to the second random number RN2 generated from the decoder 133.

If the first random number RN1 agrees with the second random number RN2, then the key K2 embedded in the card controller 120 is determined to be equal to the key K3 embedded in the host 130 and a successful authentication is achieved. Following a successful authentication, the host 130 may be permitted to retrieve data from the memory card 105 and/or store data into the memory card 105.

If the first random number RN1 disagrees with the second random number RN2, then the embedded keys K2 and K3 are determined to be different from each other and a failed authentication results.

The first random number RN1 produced by the random number generator 123 may be stored in the storage medium 110. When the first random number RN1 is being stored in the data block storing data 116 in the storage medium 110, the random number generator 123 may produce random numbers by using the first random number RN1 stored in the data block storing data 115 as a seed instead of the unique number.

The card authentication system 100 according to an embodiment of the present invention may be able to enhance the randomness of the random numbers produced by the random number generator, reinforcing a security level thereof.

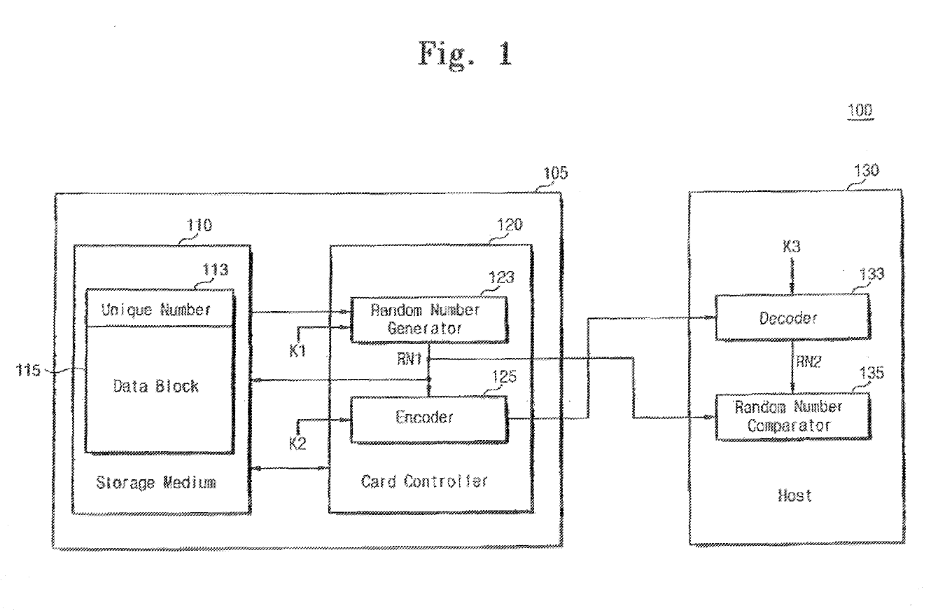

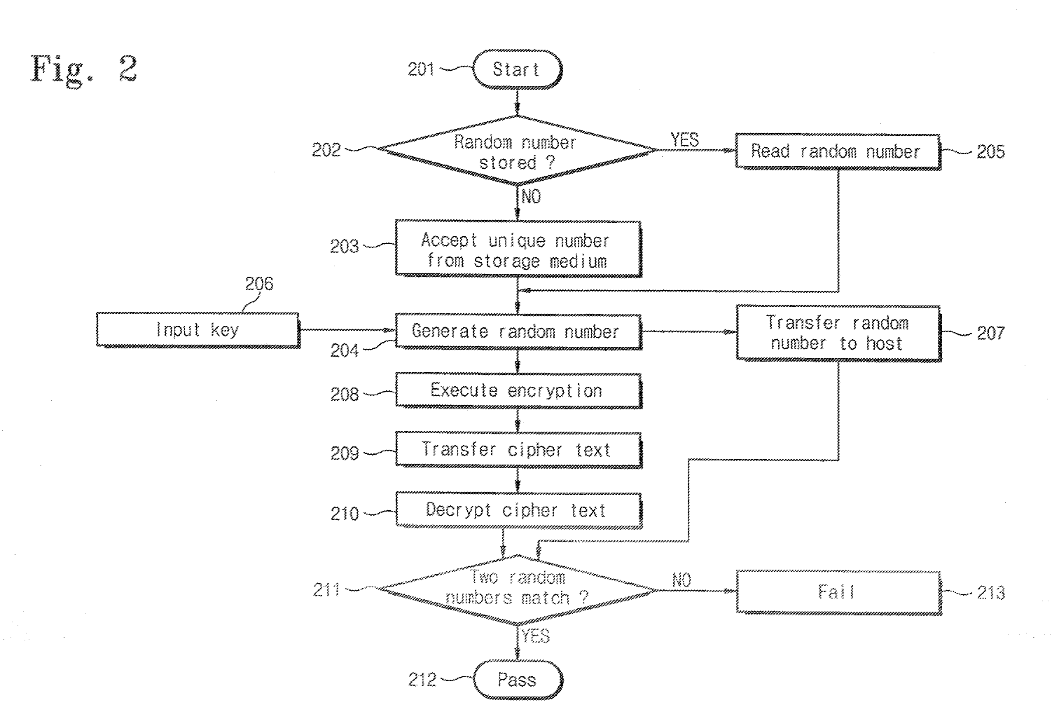

FIG. 2 is a flow chart showing a method for operating the card authentication system in accordance with an embodiment of the present invention.

First, in step 201, if the memory card 105 contacts the host 130, the card authentication system 100 may begin its authorizing operation.

Next, in step 202, the card controller 120 determines whether a random number has been stored. From the determination of step 202, if there is no random number (no, step 202), the card controller 120 receives a unique number from the block storing unique numbers 113 within the storage medium 110 (step 203). Thereafter, the random number generator 123 may produce the first random number RN1 using the unique number as a seed (step 204). If a random number has been stored, (yes, step 202), the random number generator 123 may read the stored random number and produce the first random number RN1 using the stored random number as a seed (step 204).

The random number generator 123 may further accept the first key K1 through an input by a user (step 206). The random number generator 123 may then be able to produce the first random number RN1 from the first key K1 and the unique number (step 204).

The first random number RN1 generated in the step 204 may be transferred to the host 130 (step 207). The second key K2 embedded in the card controller 120 may then be used to generate a cipher text (step 208). The cipher text generated by the step 208 may then be transferred to the host 130 (step 209). The decoder 133 of the host 130 may decrypt the cipher text by means of the third key K3 embedded therein, and the second random number RN2 may then be generated (step 210).

The second random number RN2 from the step 210 may then be compared with the first random number RN1 from the step 204 (step 211). From a result of the comparison of the step 211, if the two random numbers are equal (yes, step 211), authentication is successful and communication between the host 130 and the memory card 105 is permitted (step 212). Otherwise, if it is determined that the two random numbers are different (no, step 211), authentication is regarded as having failed (step 213).

Accordingly, the card authentication systems and methods according to embodiments of the present invention provide for enhanced randomness of random numbers and an improved level of security.

The above-disclosed subject matter is to be considered illustrative, and the present invention should not be limited to the illustrated examples and may include modifications and variations apparent to those skilled in the art. It is to be understood that any of the above-disclosed features from the various disclosed embodiments of the present invention may be joined in any possible combination and the above-disclosed features should not be understood as limited to the embodiment for which they were described. The appended claims are intended to cover all such modifications, enhancements, combinations and other embodiments, which fall within the true spirit and scope of the present invention.

What is claimed is:

1. A memory card controller comprising:
a random number generator providing a random number from one of a plurality of unique numbers accessed from a memory card storage medium; and
an encoder accepting the random number.

2. The memory card controller as set forth in claim 1, wherein the storage medium is a hard disk.

3. The memory card controller as set forth in claim 1, wherein the storage medium is a nonvolatile memory.

4. A memory card comprising:
a storage medium storing a unique number; and
a memory card controller providing a random number from one of a plurality of unique numbers and generating a cipher text from the random number.

5. The memory card as set forth in claim 4, wherein the memory card controller comprises:
a random number generator producing the random number from the one of the plurality of unique numbers; and
an encoder generating the cipher text from the random number.

6. The memory card as set forth in claim 5, wherein the random number generator receives a first key from a user and produces the random number from the one of the plurality of unique numbers and the first key.

7. The memory card as set forth in claim 5, wherein the encoder generates the cipher text form the random number and an embedded second key.

8. The memory card as set forth in claim 7, wherein the encoder transfers the random number and the cipher text to a host.

9. The memory card as set forth in claim 8, wherein the storage medium stores the random number produced from the random number generator.

10. The memory card as set forth in claim 9, wherein when the storage medium stores the random number, the random number generator produces a new random number from the stored random number.

11. The memory card as set forth in claim 4, wherein the one of the plurality of unique numbers varies depending on a type of the storage medium.

12. A memory card authentication system comprising:
a host; and
a memory card storing one of a plurality of unique numbers, generating a random number from the one of the plurality of unique numbers, generating a cipher text from the random number, and providing the cipher text to the host.

13. The memory card authentication system as set forth in claim 12, wherein the memory card comprises:
a storage medium storing the unique number; and
a memory card controller producing the random number from the one of the plurality of unique numbers and generating the cipher text from the random number.

14. The memory card authentication system as set forth in claim 13, wherein the memory card controller comprises:
a random number generator producing a first random number from the one of the plurality of unique numbers provided by the storage medium; and
an encoder generating the cipher text from the first random number.

15. The memory card authentication system as set forth in claim 14, wherein the random number generator receives a first key from a user and produces the random number from the one of the plurality of unique numbers and the first key.

16. The memory card authentication system as set forth in claim 14, wherein the encoder generates the cipher text from the first random number and an embedded second key.

17. The memory card authentication system as set forth in claim 16, wherein the encoder transfers the first random number and the cipher text to a host.

18. The memory card authentication system as set forth in claim 17, wherein the host comprises:
a decoder generating a second random number from decrypting the cipher text by means of a third key embedded in the host; and
a random number comparator configured to compare the first random number with the second random number.

19. The memory card authentication system as set forth in claim 16, wherein the storage medium stores the first random number produced from the random number generator.

20. The memory card authentication system as set forth in claim 19, wherein when the storage medium stores the first random number, the random number generator produces a new random number from the stored first random number.

21. A method for authorizing a memory card, comprising:
determining whether there is a stored random number;
accepting one of a plurality of unique numbers from a storage medium when it is determined that there is not a stored random number; and
generating a first random number from the one of the plurality of unique numbers after the one of the plurality of unique numbers has been accepted.

22. The method as set forth in claim 21, additionally comprising:
generating the first random number from the stored random number when it is determined that there is the stored random number.

23. The method as set forth in claim 22, additionally comprising: receiving a first key when the first random number is generated.

24. The method as set forth in claim 22, additionally comprising:
transferring the first random number to a host;
generating a cipher text from the first random number; and
transferring the cipher text to the host.

25. The method as set forth in claim 24, additionally comprising:
abstracting a second random number by decrypting the cipher text;
comparing the first random number with the second random number; and
identifying a successful authentication when the first random number agrees with the second random number.
